(19) United States
(12) Patent Application Publication
(10) Pub. No.: US 2024/0153697 A1
(43) Pub. Date: May 9, 2024

(54) REACTOR STRUCTURE, CONVERTER, AND POWER CONVERSION APPARATUS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Naotoshi FURUKAWA, Mie (JP); Kohei YOSHIKAWA, Mie (JP)

(21) Appl. No.: 18/281,939

(22) PCT Filed: Mar. 11, 2022
(86) PCT No.: PCT/JP2022/011055

§ 371 Date: Sep. 13, 2023

(30) Foreign Application Priority Data
Mar. 17, 2021 (JP) 2021-044122

(51) Int. Cl. H01F 37/00; H01F 27/32; H02M 3/155

(52) U.S. Cl. CPC H01F 37/00; H01F 27/324; H02M 3/155

(57) ABSTRACT

A reactor structure includes: a reactor that has a coil and a core; and a bus bar that electrically connects the coil and an external device. The reactor includes a pin that positions the busbar relative to the reactor, the busbar includes: a first piece that is overlaid onto and connected to a winding wire end portion of the core; a second piece that is connected to the external device; and a body piece that joins the first piece and the second piece to each other. The body piece includes an elongated slide hole that extends in an X direction, the X direction is a direction in which the winding wire end portion and the first piece are arranged side-by-side, and the pin is passed through the slide hole to restrict movement of the busbar in a direction that intersects the X direction and a protruding direction of the pin.

### TECHNICAL FIELD

The present disclosure relates to a reactor structure, a converter, and a power conversion apparatus.

This application claims the benefit of priority from Japanese Patent Application No. 2021-044122 filed on Mar. 17, 2021, the description of which is incorporated herein in its entirety.

### BACKGROUND

Examples of a constituent component of a converter provided in hybrid cars and the like include a reactor structure. The reactor structure disclosed in Patent Document 1 includes, for example, a reactor and a terminal member. The reactor includes a coil and a core. The coil is formed by winding a winding wire in a spiral. The reactor disclosed in Patent Document 1 also includes a frame-shaped bobbin, an inner bobbin, and a case. The frame-shaped bobbin and the inner bobbin are insulating members that ensure insulation between the coil and the core. The case houses an assembled article formed by the coil, the core, and the insulating members.

The terminal member provided in the reactor structure is also called a busbar. The busbar electrically connects the coil and an external device to each other. An end portion of the busbar is connected to an end portion of the coil through welding or the like. An intermediate portion of the busbar disclosed in Patent Document 1 is screwed to the case constituting the reactor. By screwing the busbar to the case, the busbar is positioned relative to the reactor, and thus the end portion of the busbar and the end portion of the coil can be easily connected to each other.

### PRIOR ART DOCUMENT

### Patent Document

Patent Document 1: JP 2014-130949 A

### SUMMARY OF THE INVENTION

A reactor structure according to the present disclosure including:
a reactor that has a coil and a core; and
a bus bar that electrically connects the coil and an external device to each other,
wherein the reactor includes
   a pin that positions the busbar relative to the reactor,
the busbar includes:
   a first piece that is overlaid onto and connected to a winding wire end portion of the core;
   a second piece that is connected to the external device; and
   a body piece that joins the first piece and the second piece to each other,
the body piece includes an elongated slide hole that extends in an X direction,
the X direction is a direction in which the winding wire end portion and the first piece are arranged side-by-side, and
the pin is passed through the slide hole to restrict movement of the busbar in a direction that intersects the X direction and a protruding direction of the pin.

A converter of the present disclosure includes a reactor structure of the present disclosure.

A power conversion apparatus of the present disclosure includes a converter of the present disclosure.

### BRIEF DESCRIPTION OF THE DRAWINGS

FIG. 1 is a schematic perspective view of a reactor structure according to Embodiment 1.

FIG. 2 is a schematic perspective view of an assembled article provided in the reactor structure according to Embodiment 1.

FIG. 3 is a schematic perspective view of a busbar provided in the reactor structure according to Embodiment 1.

FIG. 4 is a schematic top view of the busbar provided in the reactor structure according to Embodiment 1.

FIG. 5 is a schematic perspective view of a base portion provided in the reactor structure according to Embodiment 1.

FIG. 6 is a diagram for describing a manufacturing procedure of the reactor structure according to Embodiment 1.

FIG. 7 is a diagram for describing a positional relationship between a pin and the busbar during manufacturing of the reactor structure according to Embodiment 1.

FIG. 8 is a schematic perspective view of a busbar provided in a reactor structure according to Embodiment 2.

FIG. 9 is a schematic front view of a reactor provided in a reactor structure according to Embodiment 3.

FIG. 10 is a configuration diagram schematically showing a power supply system of a hybrid car according to Embodiment 4.

FIG. 11 is a circuit diagram schematically showing an example of a power conversion apparatus provided in a converter according to Embodiment 4.

### DETAILED DESCRIPTION TO EXECUTE THE INVENTION

### Problems to be Solved

In the reactor structure disclosed in Patent Document 1, an operation of screwing the busbar is required. Also, the number of components constituting the reactor structure is increased. Thus, the productivity of the reactor structure disclosed in Patent Document 1 is not favorable.

Thus, it is an object of the present invention to provide a reactor structure with increased productivity. It is also an object of the present disclosure to provide a converter and a power conversion apparatus with increased productivity.

### Effect of the Invention

A reactor structure, a converter, and a power conversion apparatus of the preset disclosure have increased productivity.

### DESCRIPTION OF EMBODIMENTS OF PRESENT DISCLOSURE

First, modes for carrying out the present disclosure will be listed and described.

(1) A reactor structure according to an embodiment including:
a reactor that has a coil and a core; and
a bus bar that electrically connects the coil and an external device to each other,
wherein the reactor includes
   a pin that positions the busbar relative to the reactor,
the busbar includes:
   a first piece that is overlaid onto and connected to a winding wire end portion of the core;
   a second piece that is connected to the external device; and
   a body piece that joins the first piece and the second piece to each other,
the body piece includes an elongated slide hole that extends in an X direction,
the X direction is a direction in which the winding wire end portion and the first piece are arranged side-by-side, and
the pin is passed through the slide hole to restrict movement of the busbar in a direction that intersects the X direction and a protruding direction of the pin.

The reactor structure has excellent productivity.

When manufacturing the reactor structure, simply fitting the pin into the slide hole of the busbar and sliding the busbar in the X direction brings the first piece of the busbar into abutment against the winding wire end portion. Movement of the busbar that has been slid is restricted, and thus the busbar is held to the reactor. Thus, in the reactor structure of this example, the first piece of the busbar and the winding wire end portion can be easily connected to each other even without a screw for fixing the busbar to the reactor. Thus, the reactor structure does not require a screw for fixing the busbar, nor is there a need to perform an operation to attach a screw. Accordingly, the reactor structure has excellent productivity.

(2) In the reactor structure according to the embodiment,
a configuration may be employed where the slide hole includes a large hole portion and a small hole portion that are joined to each other in the X direction,
the large hole portion is disposed on the first piece side relative to the small hole portion, and
the pin is disposed in the small hole portion in a state where the winding wire end portion and the first piece are connected.

By providing the large hole portion in the slide hole, the pin can be easily fitted into the slide hole of the busbar. When the busbar is slid in the X direction, the pin is disposed in the small hole portion. The small hole portion restricts movement of the busbar in the width direction of the small hole portion. The width direction of the small hole portion is a direction that intersects the X direction and the protruding direction of the pin. By restricting movement of the busbar in the width direction of the small hole portion, vibration of the busbar relative to the reactor can be suppressed when the reactor vibrates during driving of the reactor. Consequently, stress caused by vibration of the busbar is unlikely to act on the connection portion between the first piece and the winding wire end portion.

(3) In the reactor structure according to aspect (2),
a configuration may be employed where the pin includes:
   a shaft portion; and
   a head provided at a leading end of the shaft portion,
the shaft portion is passed through the small hole portion,
the head is disposed outside the small hole portion, and
the outer size of the head as seen in an axial direction of the shaft portion is larger than a width of the small hole portion.

The width of the small hole portion is a direction that intersects the X direction and the protruding direction of the pin, as described above. If the outer size of the head of the pin is greater than the width of the small hole portion, when the busbar vibrates in the protruding direction of the pin, the head of the pin catches on the busbar. Specifically, in the configuration of aspect (3), movement of the busbar in the width direction of the small hole portion is restricted by the shaft portion of the pin and movement of the busbar in the protruding direction of the pin is restricted by the head of the pin. Accordingly, in the configuration of aspect (3), stress caused by vibration of the busbar is less likely to act on the connection portion between the first piece and the winding wire end portion compared to the configuration of aspect (2).

(4) In the reactor structure according to aspect (3),
a configuration may be employed where the head has a shape where a portion is missing on the first piece side in the X direction, and
the large hole portion has a shape conforming to the shape of the head.

A portion of the head is missing, and thus the head has a reduced size. The shape of the inner circumferential surface of the large hole portion is a shape that corresponds to the shape of the outline of the head as seen from the axial direction of the pin. Thus, when the head is reduced in size, the size of the area occupied by the large hole portion is also reduced. Consequently, a reduction in the strength of the busbar caused by the large hole portion is suppressed.

(5) In the reactor structure according to the embodiment,
a configuration may be employed where the reactor is provided with a through hole through which a screw for fixing the reactor to an installation target is to be passed,
an axis of the through hole coincides with a Y direction or a Z direction,
the Y direction intersects the X direction and is an extension direction of the winding wire end portion,
and the Z direction intersects the X direction and the Y direction.

In general, the reactor fixed to an installation target is likely to vibrate in a direction extending along the axis of the through hole when in use. The busbar is configured to be slidable in the X direction during attachment thereof, and thus when the axis of the through hole coincides with the X direction, a large amount of stress is likely to act on the connection portion between the first piece of the busbar and the winding wire end portion. In contrast to this, in the configuration of aspect (5), the busbar is disposed such that the axis of the through hole intersects the X direction, and thus a large amount of stress is unlikely to act on the connection portion.

(6) In the reactor structure according to aspect (5),
a configuration may be employed where the axis of the through hole coincides with the Z direction, and
the pin protrudes in the Y direction.

In the configuration of aspect (6), the reactor is likely to vibrate in the Z direction that coincides with the axis of the screw shaft. In this configuration, if the pin protrudes in the Y direction that intersects the Z direction, movement of the busbar in the Z direction is restricted by the shaft portion of the pin abutting against the inner circumferential edge of the slide hole. Thus, in aspect (6), vibration of the busbar in the Z direction is effectively suppressed.

(7) In the reactor structure according to aspect (5) or (6),
a configuration may be employed where the axis of the through hole coincides with the Z direction,
the busbar has a first flat surface that is parallel with an X-Y plane,
the reactor is provided with a base portion that protrudes in the Z direction, and
the base portion is provided with a support portion that supports the first flat surface in parallel with the X-Y plane.

When attaching the busbar to the reactor, the reactor is placed on a horizontal work bench, and the busbar is attached to the reactor. In the configuration where the axis of the through hole coincides with the Z direction, the reactor is placed on the work bench such that the X-Y plane is parallel with the work bench. If this reactor includes the support portion that supports the busbar to be parallel with the X-Y plane, the busbar is unlikely to rotate about the axis thereof when being slid. Thus, when the busbar is slid and the first piece of the busbar is abutted against the winding wire end portion, the first piece is unlikely to shift from the winding wire end portion.

In the configuration of aspect (7), the busbar is supported on the support portion parallel to the X-Y plane, and thus, when the reactor vibrates in the Z direction, the busbar is likely to move as one with the reactor in the Z direction. Accordingly, a discrepancy is unlikely to occur between movement of the reactor and movement of the busbar, and vibration of the busbar relative to the reactor is likely to be suppressed.

(8) In the reactor structure according to the embodiment,
a configuration may be employed where the reactor includes an insulating member that positions the coil and the core relative to each other, and
the pin is provided as one piece with the insulating member.

The busbar is a conductive member, and thus insulation between the busbar and the coil and insulation between the busbar and the core need to be ensured. In aspect (8), the pin is formed by a portion of the insulating member, and thus insulation is ensured. Here, examples of the insulating member that positions the coil and the core relative to each other include a holding member disposed between an end portion of the coil and the core. Examples of the insulating member also include the resin molded portion that integrates the coil and the core into one piece.

(9) In the reactor structure of aspect (8)
a configuration may be employed where the insulating member is a resin molded portion that integrates the coil and the core into one piece.

The coil and the core are unlikely to separate due to the resin molded portion. Thus, the assembled article formed by the coil and the core is easy to handle.

(10) In one aspect of the reactor structure according to the embodiment,
a configuration may be employed where the reactor includes a case that houses an assembled article including the core and the coil,
the case is provided with a resin portion made of an insulating resin, and
the pin is provided as one piece with the resin portion.

As a result of the pin being formed by a portion of the resin portion, insulation is ensured between the busbar and the core. The entire case may be made of an insulating material, or a portion of the case may be made of an insulating material.

(11) A converter according to an embodiment including the reactor structure according to any one of aspects (1) to (10).

The converter includes the reactor structure of the embodiments with excellent productivity. Thus, the converter has excellent productivity.

(12) A power conversion apparatus according to an embodiment including the converter in aspect (11).

The power conversion apparatus includes the converter of the embodiment with excellent productivity. Thus, the power conversion device has excellent productivity.

### DESCRIPTION OF EMBODIMENTS OF PRESENT DISCLOSURE

Embodiments of a reactor structure, a converter, and a power conversion apparatus of the present disclosure will be described below based on the drawings. Like reference symbols in the drawings indicate like members. Note that the present invention is not limited to the configurations illustrated in the embodiments, but is indicated by the claims, and all changes that come within the meaning and range of equivalency of the claims are intended to be embraced therein.

### Embodiment 1

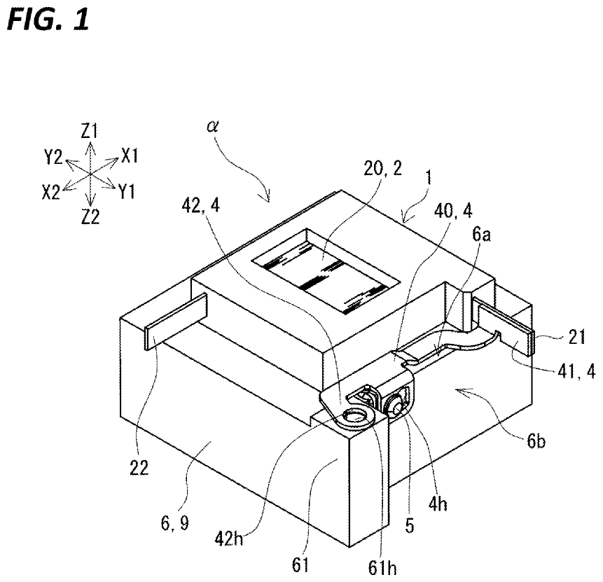

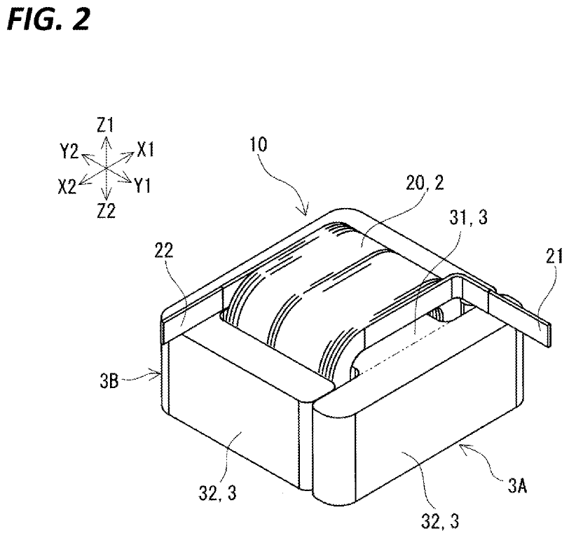

In Embodiment 1, a configuration of a reactor structure α will be described based on FIGS. 1 to 7. The reactor structure α shown in FIG. 1 includes a reactor 1 that has a coil 2 and a core 3 (FIG. 2), and a busbar 4 that electrically connects the coil 2 to an external device. The configuration of the busbar 4 is given as one example of a feature of this reactor structure α. Constituent elements included in the reactor structure are described in detail below.

[Reactor]

The reactor 1 of this example includes an assembled article 10 (FIG. 2) and an insulating member 9. The assembled article 10 is obtained by combining the coil 2 and the core 3, as shown in FIG. 2. The insulating member 9 positions the coil 2 and the core 3 relative to each other.

[Coil]

The coil 2 of this example includes a wound portion 20 formed by winding a winding wire. Known winding wires can be used as the winding wire. In this example, the winding wire is a coated flat wire. The conductor wire of the coated flat wire is formed by a copper flat wire. The insulating coating of the coated flat wire is made of enamel. The wound portion 20 is constituted by an edge-wise coil obtained by edge-wise winding the coated flat wire. In the coil 2 used in this example, one wound portion 20 is provided. Unlike this example, the coil 2 may include more than one wound portion 20. Examples include a coil 2 provided with two wound portions 20 arranged side-by-side.

The wound portion 20 has a rectangular tubular shape. Rectangular shapes encompass square shapes. That is, the end surface shape of the wound portion 20 is a rectangular frame shape. Due to the wound portion 20 having a rectangular tubular shape, the contact area between the wound portion 20 and an installation target can be easily increased, compared to a case where the wound portion has a cylindrical shape with the same cross-sectional area. Consequently, heat from the reactor structure α can be easily dissipated to the installation target via the wound portion 20. Furthermore, the stability of the wound portion 20 with respect to the installation target is increased. Corner portions of the wound portion 20 are preferably rounded.

Winding wire end portions 21 and 22 of the coil 2 extend toward the outer circumferential side of the wound portion 20. The insulating coating is stripped from the winding wire end portions 21 and 22 to expose the conductor wire. A busbar 4 is connected to the exposed conductor wire. The figures of this example only show the busbar 4 attached to the winding wire end portion 21. The configuration of the busbar attached to the winding wire end portion 22 may be the same as or different from the busbar 4 shown in the figures. The coil 2 is connected to an external apparatus via the busbar 4. The external apparatus is not shown. The external apparatus is a power supply that supplies power to the coil 2, for example.

Here, directions of the reactor structure α will be defined based on the coil 2 and the busbar 4. First, the X direction is the direction in which the winding wire end portion 21 of the coil 2 and a first piece 41 of the busbar 4 are arranged side-by-side. The first piece 41 is a portion of the busbar 4 that is connected to the winding wire end portion 21 while overlapping the same. A detailed configuration of the first piece 41 will be described below. The direction that intersects the X direction and extends along the extension direction of the wiring wire end portion 21 is the Y direction. In this example, the Y direction and the X direction are orthogonal to each other. The direction that intersects the X and Y directions is the Z direction. In this example, the Z direction is orthogonal to the X and Y directions. Further directions are defined below.
X1 direction The direction of the X direction extending toward the winding wire end portion 21 as seen from the busbar 4
X2 direction The direction opposite to the X1 direction
Y1 direction The direction of Y direction extending toward the leading end of the winding wire end portion 21
Y2 direction The direction opposite to the Y1 direction
Z1 direction The direction of Z direction extending away from installation target of the reactor 1 (the upward direction in the drawings)
Z2 direction The direction opposite to the Z1 direction

[Core]

The core 3 is a magnetic body in which a closed magnetic circuit is formed. The core 3 is constituted by a compressed powder compact, a composite material molded body, and the like. The compressed powder compact is formed by pressure molding a raw material powder including a soft magnetic powder. The soft magnetic powder is pure iron and an iron alloy, for example. The composite material molded body is obtained by filling a mixture including a soft magnetic powder and an unsolidified resin into a mold, and then solidifying the resin. In the composite material molded body, the soft magnetic powder is dispersed in the resin.

The core 3 includes an inner core portion 31 and an outer core portion 32. The inner core portion 31 is disposed in the wound portion 20 of the coil 2, and extends along the axial direction of the wound portion 20. In this example, two end portions of the core 3 along the axial direction of the wound portion 20 respectively protrude from end surfaces of the wound portion 20. The protruding portions are also portions of the inner core portion 31.

The shape of the inner core portion 31 is not particularly limited, provided that it corresponds to the internal shape of the wound portion 20. The inner core portion 31 of this example is substantially rectangular parallelepiped in shape. The inner core portion 31 may have a configuration in which divided cores and gap plates are connected, or the inner core portion 31 may be a single member.

The outer core portion 32 is a portion of the core 3 that is disposed outside the wound portion 20. The shape of the outer core portion 32 is not particularly limited, provided that end portions of the inner core portion 31 can be joined to each other. The outer core portion 32 of this example includes an end core piece that faces an end surface of the wound portion 20 in the Y1 direction, an end core piece that faces an end surface of the wound portion 20 in the Y2 direction, a side core piece that faces a side surface of the wound portion 20 in the X1 direction, and a side core piece that faces a side surface of the wound portion 20 in the X2 direction. Thus, the outer core portion 32 of this example has a rectangular annular shape as seen in the Z direction.

The core 3 of this example is constituted by two divided cores 3A and 3B. The divided core 3A is substantially T-shaped as seen from the Z direction. The divided core 3B is substantially E-shaped as seen from the Z direction. There is no particular limit on the shapes of the divided cores 3A and 3B. An example can be given where a substantially I-shaped divided core that is the inner core portion 31 and a substantially 0-shaped divided core that is the outer core portion 32 are combined. The core 3 may be constituted by three or more dived cores. An example can be given where a substantially I-shaped divided core that is the inner core portion 31 and two U-shaped divided cores that form the outer core portion 32 are combined.

[Insulating Member]

The insulating member 9 of this example is a resin molded portion 6 that integrates the coil 2 and the core 3. The resin molded portion 6 also has a function of protecting the coil 2 and the core 3 from the external environment. The resin molded portion 6 of this example does not cover the outer surfaces of the wound portion 20 in the Z direction. That is, the outer surfaces of the wound portion 20 in the Z direction are exposed from the resin molded portion 6. Consequently, heat generated by the coil 2 can easily be discharged to the outside.

The resin molded portion 6 is made of a thermoplastic resin such as a polyphenylene sulfide (PPS) resin, a polytetrafluoroethylene (PTFE) resin, a liquid crystal polymer (LCP), a polyamide (PA) resin, a polybutylene terephthalate (PBT) resin, and an acrylonitrile-buta-diene-styrene (ABS) resin. Additionally, the resin molded portion 6 may be made of a thermosetting resin such as an unsaturated polyester resin, an epoxy resin, a urethane resin, and a silicone resin. By adding a ceramics filler to these resins, the heat dissipation properties of the resin molded portion 6 can be increased. The ceramics filler is a non-magnetic powder made of alumina, silica, or the like.

The resin molded portion 6 includes a terminal base 61. The terminal base 61 is a base for supporting a connection terminal of an external device (not shown). The connection terminal is overlaid onto the surface of the busbar 4 facing in the Z1 direction and screwed thereto. The terminal base 61 is provided with a screw hole 61h to which the screw for fixing the connection terminal is attached. The screw hole 61h of this example extends in the Z direction. In this example, a nut is embedded in the terminal base 61. The inner circumferential surface of the nut forms the screw hole 61h. The axis of the screw hole 61h coincides with the axis of a later-described terminal hole 42h of the busbar 4. Thus, by screwing the connection terminal to the terminal base 61, the connection terminal is fixed to the terminal base 61 and the connection terminal is electrically connected to the busbar 4. Here, the nut is not essential. Also, the axis of the screw hole 61h may extend in a direction that intersects the Z direction.

The resin mold portion 6 does not need to entirely cover the assembled article 10. For example, the resin mold portion 6 may be configured to only cover the lower side portion of the assembled article 10. It is preferable that the lower surface of the resin mold portion 6 allows the reactor 1 to be in surface contact with the installation target (not shown). The resin mold portion 6 preferably includes an attachment portion (not shown). It is preferable that the attachment portion is provided with a through hole through which a screw for fixing the reactor 1 to the installation target is passed. In this case, the axis of the through hole preferably coincides with the Z direction.

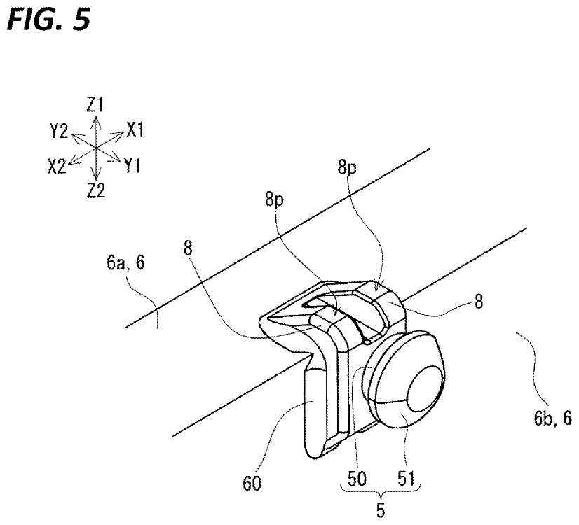

As shown in FIG. 5, the resin mold portion 6 includes a base portion 60 that has a pin 5. The base portion 60 is provided at a corner portion between a first surface 6a that faces the Z1 direction and a second surface 6b that faces the Y1 direction. Specifically, the base portion 60 is provided straddling the first surface 6a and the second surface 6b. The portion of the base portion 60 protruding from the first surface 6a in the Z1 direction is provided with a support portion 8. The portion of the base portion 60 that protrudes from the second surface 6b in the Y1 direction is provided with the pin 5. The base portion 60 and the pin 5 are formed as one piece with the resin mold portion 6.

The support portion 8 has flat surfaces 8p that are parallel with the X-Y plane and supports the later-described busbar 4. The flat surfaces 8p are parallel with the X-Y plane. There may be one or more support portions 8. There are two support portions 8 in this example. If there is more than one support portion 8, the busbar 4 is more likely to be stably supported by the support portions 8.

The pin 5 is a member that positions the busbar 4 relative to the reactor 1. The mechanism with which the busbar 4 is positioned by the pin 5 will be described in the description of the busbar 4.

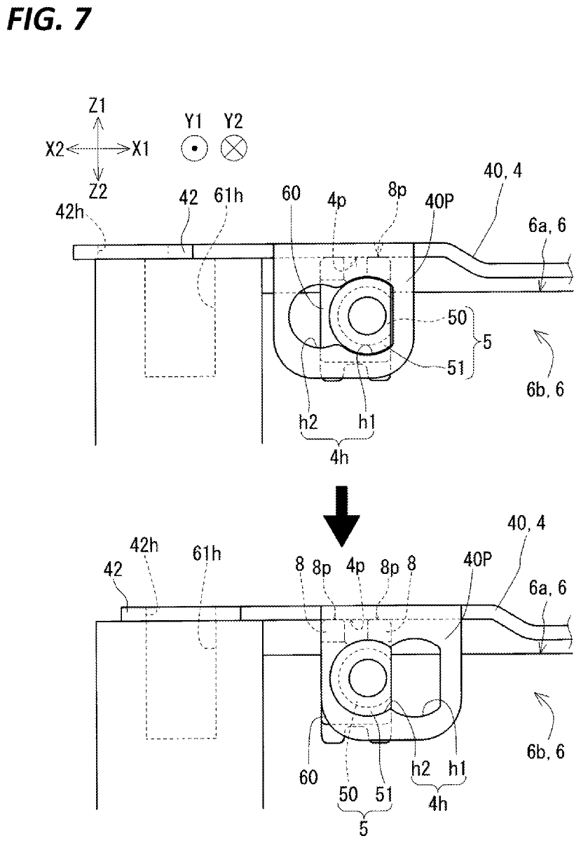

The pin 5 of this example includes a shaft portion 50 and a head 51. The shaft portion 50 is a columnar shaped body. The shaft portion 50 of this example is a round column. The head 51 is provided at the leading end of the shaft 50. The outer size of the head 51 as seen in the axial direction of the shaft portion 50 is greater than that of the shaft 50. The outer size of the head 51 is wider than a later-described small hole portion h2 of the busbar 4 (see FIGS. 4 and 7), and is slightly smaller than the size of a large hole portion h1 (see FIGS. 4 and 7). The head 51 has a shape where a portion of a circle formed by the head 51 is missing in the X1 direction, as seen from the Y direction (in particular, see FIG. 7).

[Others]

The reactor 1 may include a holding member (not shown) for holding the coil 2 and the core 3 shown in FIG. 2. The holding member is interposed between an end surface of the wound portion 20 and the outer core portion 32, and has the function of ensuring insulation between the coil 2 and the core 3. The holding member is made of an insulating material usable in manufacturing of the resin molded portion 6. That is, the holding member is an insulating member 9 that positions the coil 2 and the core 3 relative to each other. If the reactor 1 includes a holding member, the resin molded portion 6 does not need a holding member. In this case, it is preferable that the pin 5 is provided on the holding member.

[Busbar]

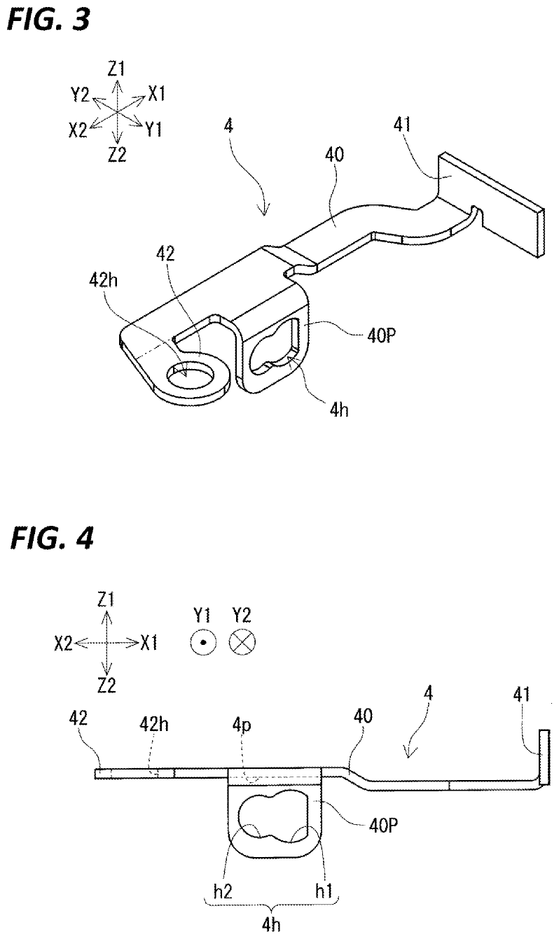

As shown in FIG. 1, the busbar 4 is a member that electrically connects the coil 2 and an external device (not shown) to each other. Thus, the busbar 4 is made of a metal with excellent conductive properties. Such a metal is, for example, copper, a copper alloy, aluminum, or an aluminum alloy. As shown in FIGS. 3 and 4, the busbar 4 includes the first piece 41, a second piece 42, and a body piece 40.

The first piece 41 is a portion that is connected to the winding wire end portion 21 of the coil 2 while overlaid thereon. The first piece 41 in this example has a rectangular plate shape. The thickness direction of the rectangular plate-shaped first piece 41 coincides with the X direction. Also, the thickness direction of the winding wire end portion 21 formed by a flat wire also coincides with the X direction. Therefore, the surface of the first piece 41 facing the X1 direction and the surface of the winding wire end portion 21 facing the X2 direction come into in surface contact with each other. The first piece 41 and the winding wire end portion 21 are connected to each other through welding, pressure welding, or the like. Examples of welding include TIG welding. Examples of pressure welding include friction stir welding. In addition, the first piece 41 and the winding wire end portion 21 may be connected to each other by fastening an annular clasp or the like from the outer circumference of the first piece 41 and the winding wire end portion 21.

The second piece 42 is a portion that is connected to an external device. The second piece 42 is disposed at a position separated from the first piece 41 in the X2 direction. In FIG. 3, the boundary between the second piece 42 and the body piece 40 is marked with a double dot-dash line. The second piece 42 of this example is a flat plate-shaped piece that is connected to a connection terminal of the external device. The thickness direction of the second piece 42 coincides with the Z direction. The second piece 42 is provided with the terminal hole 42h that extends therethrough in the thickness direction of the second piece 42. The axis of the terminal hole 42h coincides with the Z direction. This terminal hole 42h coincides with the screw hole 61h in the terminal base 61 of the resin molded portion 6. By overlapping the surface of the second piece 42 facing the Z1 direction with the connection terminal of the external device and screwing them together, the second piece 42 and the connection terminal can be electrically connected to each other.

The body piece 40 is a portion that joins the first piece 41 and the second piece 42. The body piece 40 of this example has a plate shape that extends in the X direction. The intermediate portion of the body piece 40 in the X direction is bent. This bent portion is for matching the height of the second piece 42 with the height of the terminal base 61. The body piece 40 is provided with an extension portion 40P at a portion on the X2 side of the intermediate portion thereof. The thickness direction of the portions of the body piece 40 excluding the extension portion 40P coincides with the Z direction. Thus, the body piece 40 and the first piece 41 are joined substantially at a right angle.

As shown in FIG. 4, the portion of the surface of the body piece 40 facing the Z2 direction that is continuous to the extension portion 40P forms a flat first flat surface 4p. The first flat surface 4p is located at a position corresponding to the flat surfaces 8p of the support portion 8 on the resin molded portion 6 (see FIG. 5). The first flat surface 4p is supported by the flat surfaces 8p. The flat surfaces 8p are parallel to the X-Y plane, and thus the first flat surface 4p supported by the flat surfaces 8p is also parallel to the X-Y plane. Thus, the busbar 4 is stably supported on the support portions 8. In a configuration of the present example where the busbar 4 and the resin molded portion 6 are in flat-surface contact with each other, the busbar 4 is likely to move as one with the reactor 1 in the Z direction when the reactor 1 vibrates in the Z direction. Thus, there is unlikely to be a discrepancy between movement of the reactor 1 and movement of the busbar 4, and it is easier to suppress the action of vibration of the busbar 4 on the reactor 1.

The extension portion 40P included in the body piece 40 is provided on the body piece 40 at a position toward the second piece 42. The extension portion 40P has a flat plate shape. The thickness direction of the extension portion 40P coincides with the Y direction. As a result of the body piece 40 including the extension portion 40P, the body piece 40 catches on the corner portion between the first surface 6a and the second surface 6b of the resin molded portion 6, and thus the busbar 4 is less likely to rotate about the X axis.

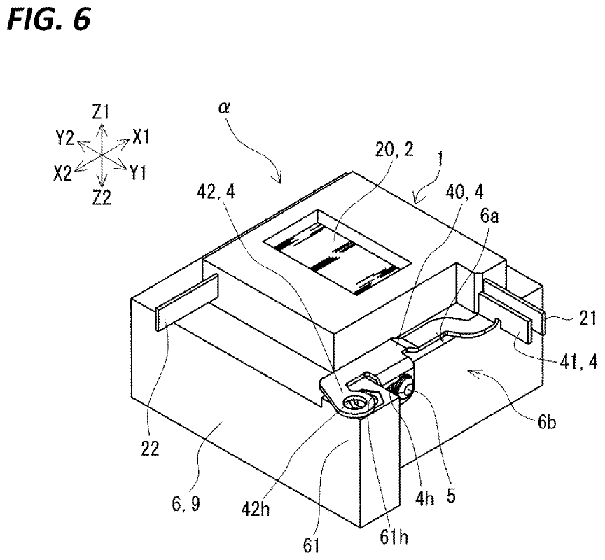

The extension portion 40P of the body piece 40 is provided with a slide hole 4h. The slide hole 4h is used when attaching the busbar 4 to the reactor 1. The specific attachment procedure of the busbar 4 is described in the item “Attachment Procedure of Busbar” in reference to FIGS. 6 and 7.

The slide hole 4h is an elongated hole extending in the X direction. The axial direction of the slide hole 4h coincides with the Y direction. The slide hole 4h of this example includes the large hole portion h1 and the small hole portion h2. The large hole portion h1 and the small hole portion h2 are joined to each other in the X direction. The large hole portion h1 is disposed on the X1 direction side of the small hole portion h2. That is, the large hole portion h1 is disposed on the first piece 41 side relative to the small hole portion h2.

The large hole portion h1 is used to attach the busbar 4 to the reactor 1 (see upper block in FIG. 7). The large hole portion h1 has a shape corresponding to the shape of the head 51 of the pin 5 as seen from the Y direction. More specifically, the X1 direction-side portion of the large hole portion h1 is straight in the Z direction. The internal size of the large hole portion h1 is slightly larger than the outer size of the head 51. Thus, the head 51 can be passed through the large hole portion h1.

The small hole portion h2 is used for disposing the busbar 4 at a predetermined position of the reactor 1 (see lower block of FIG. 7). The small hole portion h2 has a shape that conforms to the shape of the shaft portion 50 of the pin 5 as seen from the Y direction. In the reactor structure α (FIG. 1), the shaft portion 50 is disposed in the small hole portion h2. The width of the small hole portion h2, i.e. the length of the small hole portion h2 in the Z direction, is slightly larger than that of the shaft portion 50. Thus, when the busbar 4 vibrates in the Z direction, the shaft portion 50 catches on the inner circumferential surface of the small hole portion h2. Movement of the busbar 4 in the Z direction is restricted by the shaft portion 50, and thus vibration of the busbar 4 in the Z direction relative to the reactor 1 is suppressed. Accordingly, stress caused by vibration of the busbar 4 is unlikely to act at the connection portion between the first piece 41 and the winding wire end portion 21.

The width of the small hole portion h2, i.e., the length of the small hole portion h2 in the Z direction, is smaller than the outer size of the head 51. Thus, when the busbar 4 vibrates in the Y direction, the flat surface of the extension portion 40P facing in the Y1 direction catches on the head 51. Movement of the busbar 4 in the Y direction is restricted by the head 51, and thus vibration of the busbar 4 in the Y direction relative to the reactor 1 is suppressed. Accordingly, stress caused by vibration of the busbar 4 is unlikely to act on the connection portion between the first piece 41 and the winding wire end portion 21.

[Attachment Procedure of Busbar]

The attachment procedure of the busbar 4 will be described based on FIGS. 6 and 7. First, as shown in FIG. 6, the pin 5 of the reactor 1 is attached to the busbar 4. At this time, as shown in the upper block of FIG. 7, the head 51 of the pin 5 is passed through the large hole portion h1 of the slide hole 4h. At this point in time, as shown in FIG. 6, the first piece 41 of the busbar 4 is located at a position separated from the winding wire end portion 21. Also, the terminal hole 42h of the busbar 4 is also located a position shifted from the screw hole 61h of the terminal base 61.

Next, the busbar 4 is slid in the X1 direction. Consequently, as shown in the lower block of FIG. 7, the shaft portion 50 of the pin 5 is disposed in the small hole portion h2. At this time, the first flat surface 4p of the busbar 4 is guided along the flat surfaces 8p of the support portions 8. Thus, the busbar 4 is stably slid without rotating about the X axis. The terminal hole 42h of the slid busbar 4 is aligned with the screw hole 61h of the terminal base 61. Also, as shown in FIG. 1, the first piece 41 is abutted against the winding wire end portion 21. As a result of the slide hole 4h being guided along the shaft portion 50, the first piece 41 is accurately positioned at the connection portion of the winding wire end portion 21. In this manner, in the configuration of this example, simply sliding the busbar 4 in the X direction along the pin 5 fitted thereto brings the first piece 41 of the busbar 4 into abutment against the winding wire end portion 21.

Lastly, the first piece 41 and the winding wire end portion 21 are joined to each other through welding or the like. At this time, movement of the busbar 4 is restricted by the pin 5, and thus the first piece 41 of the busbar 4 and the winding wire end portion 21 can be easily joined to each other.

[Installation Procedure of Reactor Structure]

The reactor structure α in FIG. 1 is screwed to an installation target, for example. Examples of the installation target include a converter case housing a converter, for example. A connection terminal of an external device is connected to the reactor structure α screwed to the installation target. Here, when the connection terminal is screwed to the terminal base 61, torque is generated that causes the busbar 4 to rotate about the screw axis. In the configuration of this example, movement of the busbar 4 in the Y1 direction is restricted by the head 51 of the pin 5. Thus, it is possible to suppress excessive torque from acting on the connection portion between the first piece 41 and the winding wire end portion 21.

[Effects]

In the reactor structure α of this example, no screw for fixing the busbar 4 to the reactor 1 is required. Thus, the reactor structure α does not require a screw to fix the busbar 4 and thus there is also no need to perform an operation to attach a screw. Accordingly, the reactor structure α of this example has excellent productivity.

In the reactor structure α of this example, vibration of the busbar 4 in the Y direction and the Z direction is suppressed by the pin 5 that has the head 51. Thus, stress caused by vibration of the busbar 4 is unlikely to act on the connection portion between the first piece 41 and the winding wire end portion 21. Accordingly, even if the intermediate portion of the busbar 4 is not screwed as in a conventional technology, reliability of the connection portion is ensured.

[Variation 1]

The slide hole 4h may have an elongated hole shape with a constant width. In this case, the pin 5 passed through the slide hole 4h is constituted only by the shaft portion 50.

[Variation 2]

The pin 5 may be provided on the core 3. For example, a pin may be provided on the outer core portion 32 of the core 3. In this case, the pin 5 and the busbar 4 need to be insulated from each other. For example, an insulative coating can be formed on at least one of the outer circumference of the pin 5 and the outer circumference of the busbar 4. When the core 3 is formed by a composite material molded body, the pin 5 is easy to form.

### Embodiment 2

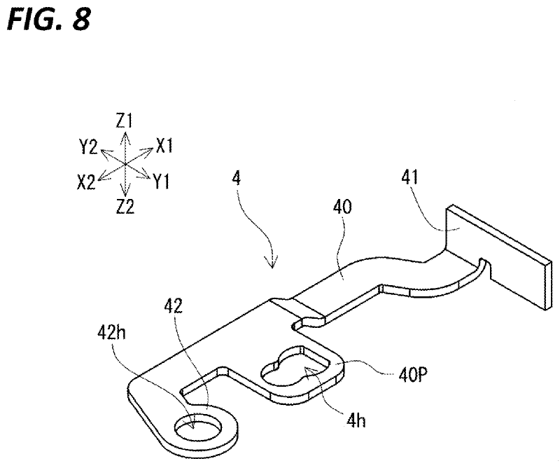

In Embodiment 2, a reactor structure in which the shape of the busbar 4 differs from that in Embodiment 1 will be described based on FIG. 8. Only the busbar 4 is shown in FIG. 8.

Similarly to the busbar 4 of Embodiment 1, the busbar 4 of this example includes the body piece 40, the first piece 41, and the second piece 42. The shapes of the first piece 41 and the second piece 42 are the same as those in Embodiment 1.

The body piece 40 includes the flat plate-shaped extension portion 40P that protrudes in the Y1 direction. The thickness direction of the extension portion 40P coincides with the Z direction. The extension portion 40P, which is a portion of the body piece 40, is provided with the slide hole 4h that has the same shape as that in Embodiment 1. The thickness direction of the extension portion 40P coincides with the Z direction, and thus the axial direction of the slide hole 4h coincides with the Z direction.

The pin (not shown) that is passed through the slide hole 4h of the busbar 4 of this example extends in the Z1 direction. The shape of the pin is the same as the shape of the pin 5 shown in FIG. 5.

In the configuration of this example, vibration of the busbar 4 in the Z direction is suppressed by the head of the pin. Also, vibration of the busbar 4 in the Y direction is suppressed by the shaft portion of the pin.

### Embodiment 3

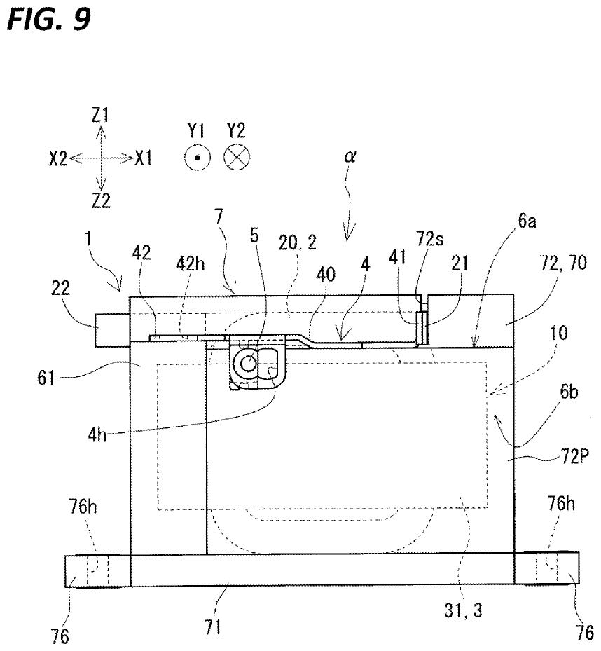

In Embodiment 3, the reactor structure α including a case 7 housing the assembled article 10 is described based on FIG. 9. The case 7 is a portion of the reactor 1.

The case 7 includes a resin portion 70 in which at least a portion thereof in contact with the busbar 4 is made of an insulating material. The case 7 of this example includes a bottom plate portion 71 on which the assembled article 10 is placed and a side wall portion 72 that covers a side surface of the assembled article 10. In the case of this example, the entire side wall portion 72 is formed by the resin portion 70.

The side wall portion 72 of this example is located at a higher position than the end portion of the assembled article 10 in the Z1 direction. Thus, the entire assembled article 10 is housed in the case 7. The side wall portion 72 is provided with a slit 72s through which the winding wire end portion 21 of the assembled article 10 housed in the case 7 is lead to the outside of the case 7. The portion of the side wall portion 72 below the slit 72s is an extension portion 72P protruding relatively in the Y1 direction. The surface of the extension portion 72P facing the Z1 direction has the same role as the first surface 6a in Embodiment 1. Also, the surface of the extension portion 72P facing the Y1 direction has the same role as the second surface 6b in Embodiment 1. Thus, the extension portion 72P in this example is provided with the pin 5 and the terminal base 61. The configurations of the pin 5 and the terminal base 61 are the same as those in Embodiment 1.

The bottom plate portion 71 may be made of an insulating material or metal. The metal bottom plate portion 71 has excellent rigidity and thermal conductivity. It is preferable to dispose an insulating sheet between the metal bottom plate portion 71 and the assembled article 10. The bottom plate portion 71 is provided with a plurality of attachment portions 76. The attachment portions 76 of the bottom plate portion 71 are for fixing the case 7 to the installation target. Each attachment portion 76 is provided with a through hole 76h. The axis of each through hole 76h coincides with the Z direction. A screw for fixing the case 7 to the installation target is disposed in each through hole 76h.

With the configuration of this example as well, the busbar 4 can be stably attached to the reactor 1. Thus, in the configuration of this example as well, there is no need to fix the intermediate portion of the busbar 4 with a screw.

### Embodiment 4

[Converter and Power Conversion Apparatus]

The reactor structure α according to the embodiments can be used for an application that meets the following conduction conditions. Examples of the conduction conditions include the maximum DC current being approximately 100 A or more and 1000 A or less, the average voltage being approximately 100 V or more and 1000 V or less, and the usage frequency being approximately 5 kHz or more and 100 kHz or less. The reactor structure α according to an embodiment can typically be used for a constituent component of a converter mounted in a vehicle such as an electric or hybrid car, or a constituent component of a power conversion apparatus including this converter.

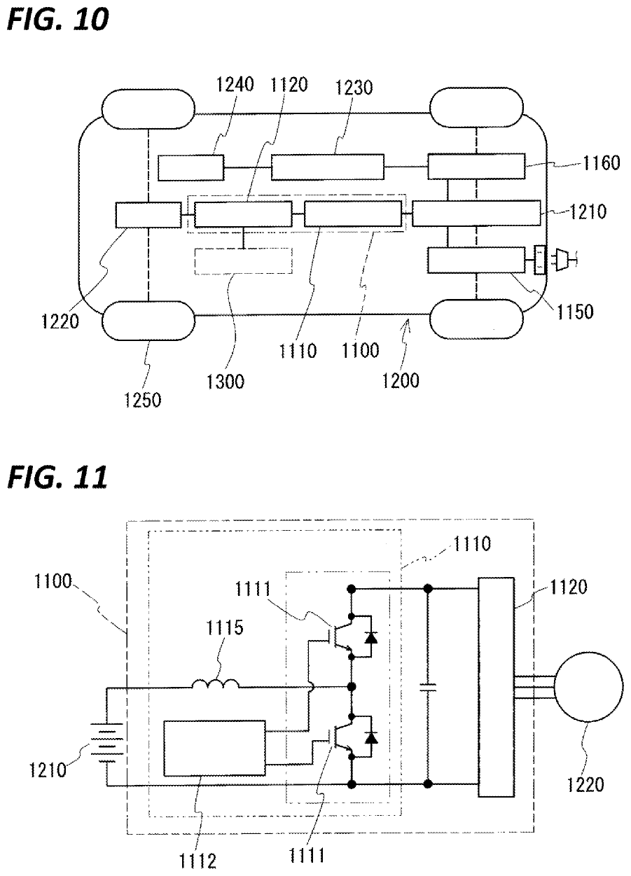

A vehicle 1200 such as a hybrid or electric car includes, as shown in FIG. 10, a main battery 1210, a power conversion apparatus 1100 connected to the main battery 1210, and a motor 1220 that is driven by power supplied from the main battery 1210 and used to cause the vehicle 1200 to travel. The motor 1220 is typically a three phase AC motor, and drives wheels 1250 during travel and functions as a generator during regeneration. When the vehicle 1200 is a hybrid car, the vehicle 1200 includes an engine 1300 in addition to the motor 1220. In FIG. 10, an inlet is shown as the charging region of the vehicle 1200, but a mode including a plug can be employed.

The power conversion apparatus 1100 has a converter 1110 that is connected to the main battery 1210, and an inverter 1120 that is connected to the converter 1110 and converts between AC and DC. The converter 1110 shown in this example steps up the input voltage of the main battery 1210 at approximately 200 V or more and 300 V or less to approximately 400 V or more and 700 V or less while the vehicle 1200 is traveling, and supplies power to the inverter 1120. The converter 1110 steps down the input voltage output from the motor 1220 via the inverter 1120 to a DC voltage suitable for the main battery 1210 during regeneration, and charges the main battery 1210 with the resulting voltage. The input voltage is a DC voltage. The inverter 1120 converts the DC stepped up by the converter 1110 to a predetermined AC and supplies the resulting current to the motor 1220 while the vehicle 1200 is travelling, and converts an AC output from the motor 1220 to a DC, and outputs the resulting DC to the converter 1110 during regeneration.

The converter 1110 includes, as shown in FIG. 11, a plurality of switching elements 1111, a driving circuit 1112 that controls operations of the switching elements 1111, and a reactor structure 1115, and converts an input voltage by repeating ON/OFF operations. Here, stepping up or down of a voltage is performed as converting an input voltage. Power devices such as FET transistors or insulated-gate bipolar transistors are used as the switching elements 1111. The reactor structure 1115 uses the properties of a coil that acts to hinder changes in current trying to flow through a circuit, and has a function of smoothening changes in current that is increased or reduced by switching operations. Any one reactor structure α in Embodiments 1 to 3 is provided as the reactor structure 1115. By providing the reactor structure α that is light and has excellent electromagnetic properties or the like, the power conversion apparatus 1100 and the converter 1110 are light and have excellent conversion efficiency.

The vehicle 1200 includes, in addition to the converter 1110, a power supply apparatus converter 1150 connected to the main battery 1210, and an auxiliary device power source converter 1160 that is connected to a sub-battery 1230, which is a power source of auxiliary devices 1240, and the main battery 1210, and that converts a high voltage of the main battery 1210 to a low voltage. The converter 1110 typically performs DC-DC conversion, but the power supply apparatus converter 1150 and the auxiliary device power source converter 1160 perform AC-DC conversion. There are also power supply apparatus converters 1150 that perform DC-DC conversion. The reactor structure 1115 of the power supply apparatus converter 1150 and the auxiliary device power source converter 1160 can use a reactor structure that has a similar configuration as a reactor structure α or the like in Embodiments 1 to 3, and in which the size and shape has been appropriately modified. Also, a reactor structure α or the like in Embodiments 1 to 3 can also be used as a converter that converts input power and only steps up or steps down a voltage.

### LIST OF REFERENCE NUMERALS

α Reactor structure
1 Reactor
   10 Assembled article
2 Coil
   20 Wound portion, 21, 22 Winding wire end portion
3 Core
   3A, 3B Divided core
   31 Inner core portion, 32 Outer core portion
   4 Busbar
   40 Body piece, 40P Extension portion
   41 First piece
   42 Second piece, 42h Terminal hole
   4h Slide hole, h1 Large hole portion, h2 Small hole portion
   4p First flat surface
5 Pin
   50 Shaft portion, 51 Head
6 Resin molded portion
   6a First surface, 6b Second surface
   60 Base portion
   61 Terminal base, 61h Screw hole
7 Case
   70 Resin portion, 71 Bottom plate portion,
   72 Side wall portion, 72P Extension portion
   76 Attachment portion, 76h Through hole
8 Support portion
   8p Flat surface
9 Insulating member
1100 Power conversion apparatus
   1110 Converter, 1111 Switching element, 1112 Driving circuit
   1115 Reactor structure, 1120 Inverter
   1150 Power supply apparatus converter,
   1160 Auxiliary device power source converter
1200 Vehicle
   1210 Main battery, 1220 Motor, 1230 Sub-battery
   1240 Auxiliary devices, 1250 Wheel
1300 Engine

1. A reactor structure comprising:
a reactor that has a coil and a core; and
a bus bar that electrically connects the coil and an external device to each other,
wherein the reactor includes
a pin that positions the busbar relative to the reactor,
the busbar includes:
a first piece that is overlaid onto and connected to a winding wire end portion of the core;
a second piece that is connected to the external device; and
a body piece that joins the first piece and the second piece to each other, the body piece includes an elongated slide hole that extends in an X direction,
the X direction is a direction in which the winding wire end portion and the first piece are arranged side-by-side, and
the pin is passed through the slide hole to restrict movement of the busbar in a direction that intersects the X direction and a protruding direction of the pin.

2. The reactor structure according to claim 1,
wherein the slide hole includes a large hole portion and a small hole portion that are joined to each other in the X direction,
the large hole portion is disposed on the first piece side relative to the small hole portion, and
the pin is disposed in the small hole portion in a state where the winding wire end portion and the first piece are connected.

3. The reactor structure according to claim 2,
wherein the pin includes:
a shaft portion; and
a head provided at a leading end of the shaft portion,
the shaft portion is passed through the small hole portion,
the head is disposed outside the small hole portion, and
the outer size of the head as seen in an axial direction of the shaft portion is larger than a width of the small hole portion.

4. The reactor structure according to claim 3,
wherein the head has a shape where a portion is missing on the first piece side in the X direction, and
the large hole portion has a shape conforming to the shape of the head.

5. The reactor structure according to claim 1,
wherein the reactor is provided with a through hole through which a screw for fixing the reactor to an installation target is to be passed,
an axis of the through hole coincides with a Y direction or a Z direction,
the Y direction intersects the X direction and is an extension direction of the winding wire end portion,
and the Z direction intersects the X direction and the Y direction.

6. The reactor structure according to claim 5,
wherein the axis of the through hole coincides with the Z direction, and
the pin protrudes in the Y direction.

7. The reactor structure according to claim 5,
wherein the axis of the through hole coincides with the Z direction,
the busbar has a first flat surface that is parallel with an X-Y plane,
the reactor is provided with a base portion that protrudes in the Z direction, and
the base portion is provided with a support portion that supports the first flat surface in parallel with the X-Y plane.

8. The reactor structure according to claim 1,
wherein the reactor includes an insulating member that positions the coil and the core relative to each other, and
the pin is provided as one piece with the insulating member.

9. The reactor structure according to claim 8,
wherein the insulating member is a resin molded portion that integrates the coil and the core into one piece.

10. The reactor structure according to claim 1,
wherein the reactor includes a case that houses an assembled article including the core and the coil,
the case is provided with a resin portion made of an insulating resin, and
the pin is provided as one piece with the resin portion.

11. A converter comprising the reactor structure according to claim 1.

12. A power conversion apparatus comprising the converter in claim 11.
